(19) United States
(12) Patent Application Publication
(10) Pub. No.: US 2023/0125944 A1
(43) Pub. Date: Apr. 27, 2023

(54) OIL AND GAS RESERVOIR SIMULATOR

(71) Applicants: Qatar Foundation for Education, Science and Community Development, Doha (QA); Board of Trustees of the Leland Stanford Junior University, Stanford, CA (US)

(72) Inventors: Ahmad Sami Abushaika, Doha (QA); Kirill Terekhov, Doha (QA); Longlong Li, Doha (QA); Hamdi Tchelepi, Doha (QA); Denis Voskov, Doha (QA)

(21) Appl. No.: 17/973,212

(22) Filed: Oct. 25, 2022

Related U.S. Application Data
(60) Provisional application No. 63/271,512, filed on Oct. 25, 2021.

(51) Int. Cl. G01V 99/00

(52) U.S. Cl. CPC G01V 99/005

(57) ABSTRACT

A reservoir simulation platform is provided. The reservoir simulation platform includes a mimetic finite discretization scheme and an operator-based linearization approach. The reservoir simulation system further includes a parallel framework for coupling the mimetic finite discretization scheme and the operator-based linearization approach.

### CROSS-REFERENCES TO RELATED APPLICATIONS

The present disclosure claims priority to U.S. Provisional Patent Application 63/271,512 titled “QASR Reservoir Simulator” having a filing date of Oct. 25, 2021, the entirety of which is incorporated herein.

### BACKGROUND

Reservoir simulations are computer models that are used to predict the flow of fluids through porous materials. Because oil and gas fields are located beneath the earth's surface, many oil and gas companies rely on reservoir simulations to develop their hydrocarbon fields. For example, a reservoir simulator could be used to estimate the amount of reserves, which is one factor that companies use to develop production scenarios. Currently, reservoir simulators are outdated and provide incorrect data, which negatively impacts the amount of hydrocarbon the companies can extract.

### SUMMARY

The present disclosure generally relates to a reservoir simulation platform.

In light of the present disclosure, and without limiting the scope of the disclosure in any way, in an aspect of the present disclosure, which may be combined with any other aspect listed herein unless specified otherwise, a system for reservoir simulation platform is provided. The reservoir simulation platform includes a mimetic finite discretization scheme and an operator-based linearization approach.

In an aspect of the present disclosure, which may be combined with any other aspect listed herein unless specified otherwise, the mimetic finite discretization scheme and the operator-based linearization approach are coupled with a parallel framework.

In an aspect of the present disclosure, which may be combined with any other aspect listed herein unless specified otherwise, method of operations, a system including a processor and a memory that includes instructions that when executed by the processor perform operations, and a non-transitory computer-readable storage medium including instructions that when executed by a processor perform operations are provided, wherein the operations include: reading in simulation parameters for a simulated oil and gas reservoir site; solving an initial iteration of nonlinear equations for simulating the simulated oil and gas reservoir site based on the simulation parameters; estimating initial operator values and initial derivatives of the initial operator values for the simulated oil and gas reservoir site until the initial operator values meet a convergence criteria with the initial derivatives; producing an initial output based on the initial operator values; solving a final iteration of the nonlinear equations for simulating the simulated oil and gas reservoir site based on the simulation parameters and the initial output; estimating final operator values and final derivatives of the final operator values for the simulated oil and gas reservoir site until the final operator values meet the convergence criteria with the final derivatives; and loading oil and gas survey results into cells of a mesh representing the simulated oil and gas reservoir site based on the final output.

The reader will appreciate the foregoing details, as well as others, upon considering the following detailed description of certain non-limiting embodiments including a reservoir simulation platform according to the present disclosure.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

FIG. 1 illustrates a computational model for solving the various governing equations used by an oil and gas reservoir simulator, according to embodiments of the present disclosure.

FIG. 2 is a flowchart of an example method of providing an oil and gas reservoir simulator, according to embodiments of the present disclosure.

FIG. 3 illustrates a computer system, according to aspects of the present disclosure.

### DETAILED DESCRIPTION

The present disclosure generally relates to a reservoir simulation platform. Conventional reservoir simulation platforms include various disadvantages due to constraints from various factors, such as full tensor permeability, the unstructured grid required for characterization of complex geographical models, the complex phase behavior of many flow systems, and the model's large grid number. Thus, aspects of the present disclosure may address the above-discussed constraints in the conventional reservoir simulation platforms.

According to an embodiment of the present disclosure, a reservoir simulation platform may include three different components: (1) a mimetic finite discretization scheme, (2) an operator-based linearization approach, and (3) a parallel framework.

Due to the uncertainties and complex structures of the features underground, it is always challenging for a decision-maker to perform smart field management. Reservoir simulation that is used to model multiphase flow in porous media in the subsurface can assist in geological model quantification and development strategy optimization. However, the further application of this technology is constrained by several factors such as a full tensor permeability, which is usually introduced by the coarsening technology of the geological model, is quite challenging for the most commonly used two-point flux approximation (TPFA) approach, the unstructured grid used for characterization of complex geological models brings challenges to the TPFA method as well, the complex phase behavior may lead to a severe nonlinearity of the flow system, and a full-resolution high-fidelity geological model required for a high accurate simulation leads to huge grid number.

Essentially, what the full tensor permeability and unstructured grid introduce is a non-K-orthogonal mesh. The TPFA method which is widely used in commercial simulators cannot handle this kind of mesh due to the inconsistency on it. It cannot guarantee accurate and convergent solutions and advanced spatial discretization schemes are still needed. Therefore, significant work has been done to deal with that such as the multipoint flux approximation (MPFA) derived from finite volume discretization, mixed-finite-element method (MFEM), mixed-hybrid finite-element (MHFE) method, and mimetic finite difference (MFD) derived from the finite element method. Since these schemes hold more points to approximate the flux than the TPFA, they have potential to handle the non-K-orthogonal mesh and are proven to be able to provide more accurate solutions.

In the present disclosure, the mimetic finite discretization (“MFD”) scheme is capable of handling full tensor permeability and the unstructured grid to discretize the conservation equations, which are two constraint in a conventional reservoir simulation platform. Further, the implementation of the operator-based linearization (“OBL”) approach seeks to address the complex phase behavior of many flow systems. Specifically, the terms used in the software, which are dependent on rock and fluid properties but are independent of spatially distributed properties, are reduced into simple operators, which allows the presently described system to uniformly discretize the space of physical statuses for a simplified representation of the operators.

The present disclosure provides a fully-implicit parallel framework for complex reservoir simulations using the mimetic finite difference method and operator-based linearization approach. The success in first coupling the state-of-the-art discretization and linearization schemes in a parallel framework improves the simulation capabilities for complex cases. As a multipoint scheme, the MFD scheme introduces an unknown on the faces and defines a momentum equation on those faces. By coupling the momentum equation and mass balance equations together and solving the equations simultaneously, the MFD scheme holds great potential in simulating complex cases holding a full tensor permeability and unstructured grid.

The OBL approach reduces the rock and fluid properties in the governing equations into simple operators, which improves computational efficiency via the linearization of the nonlinear system in multiphase flow problems. Initially the OBL approach analyzes operator values on the nodes that are uniformly defined on the space of physical status. During a simulation run, the operator values and their derivatives, required for the assembly of the Jacobian matrix and residual vector, can be determined by multi-linear interpolation. This approach can drastically simplify the implementation of the implicit schemes and further improve computational efficiency.

By benchmarking the numerical solutions against a Buckley-Leverett analytical solution, the framework described in present disclosure has been demonstrated to be capable to provide accurate solutions for multiphase flow problems. The MFD scheme can thereby provide reliable solutions at a geological scale for complex multiphase flow problems holding strong heterogeneities, a full tensor permeability, and an unstructured grid. The results demonstrated that the OBL, which is an approximation approach in essence and may introduce errors to some extent, works very well with the multipoint scheme MFD. As the MFD scheme introduces an unknown on the faces, the implementation is more difficult than that of MPFA-O when the new unknowns also bring challenges to the linear solver. However, the MFD holds a great potential for complex reservoir simulations since it could produce more accurate results than the MPFA-O.

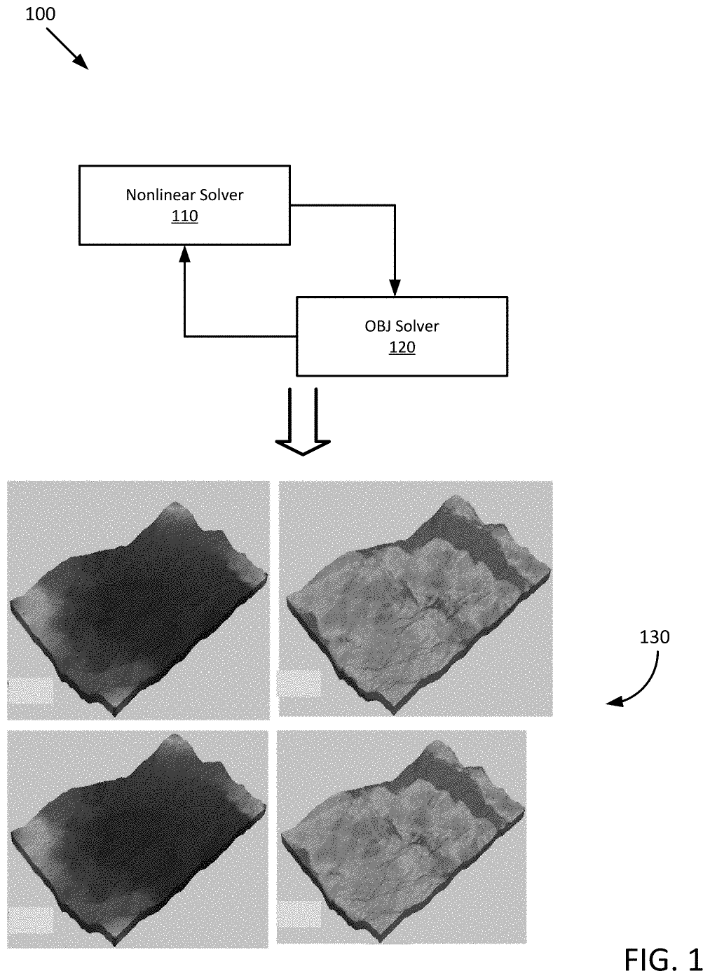

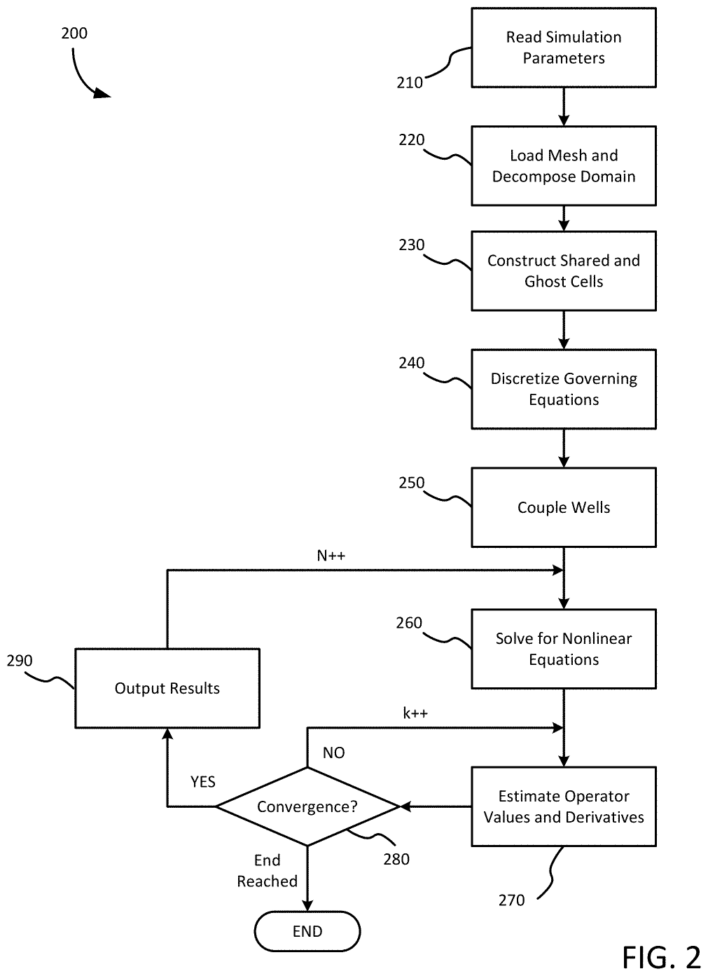

FIG. 1 illustrates a computational model 100 for solving the various governing equations used by an oil and gas reservoir simulator, such as according to method 200 described in relation to FIG. 2, according to embodiments of the present disclosure. Oil, gas, and water may exist in three phases underground, and the transport equations of the black oil model may be understood with reference to Formulas 1-5 below. In these formulas, t is time; ϕ is the reservoir porosity; ρ is the phase density; S is the saturation; B is the formation volume factor; R is the gas solubility; subscripts g, o, and w represent gas, oil, and water respectively and subscript st represents the standard condition; q is the component rate per unit volume; u is the velocity; K is the permeability tensor; kᵣₐ is the relative permeability of phase α; μ is the viscosity; p is the pressure; γₐ=ρ_{α}g is the gravity gradient in vertical direction; and D is the vector of the vertical depth that is positive downward.

$$\frac{\partial }{\partial t} [ ϕ ( {ρ}_{w} {S}_{w} + \frac{{ρ}_{g s t}}{{B}_{o}} {R}_{g} {S}_{o} ) ] + ∇ \cdot ( {ρ}_{w} {u}_{w} + \frac{{ρ}_{g s t}}{{B}_{o}} {R}_{g} {u}_{o} ) + {q}_{g} = 0 \qquad Formula 1$$

$$\frac{\partial }{\partial t} ( ϕ {ρ}_{0} {S}_{o} ) + ∇ \cdot ( {ρ}_{0} {u}_{o} ) + {q}_{0} = 0 \qquad Formula 2$$

$$\frac{\partial }{\partial t} ( ϕ {ρ}_{w} {S}_{w} ) + ∇ \cdot ( {ρ}_{w} {u}_{w} ) + {q}_{w} = 0 \qquad Formula 3$$

$${u}_{a} = - \frac{K {k}_{r a}}{{μ}_{a}} ( ∇ p - {γ}_{a} ∇ D \qquad Formula 4$$

$${S}_{g} + {S}_{o} + {S}_{w} = 1 \qquad Formula 5$$

The nonlinear solver 110 discretizes these governing formulas according to the MFD scheme to yield the flux on interface i according to Formulas 6 and 7, below

$${ψ}_{α , i} = {A}_{i} [ {\sum }_{{w}_{i}} ( p - {γ}_{a} D ) - {\sum }_{j = 1}^{{N}_{f}} ( {W}_{i j} ( {π}_{j} - {γ}_{α} {π}_{j , D} ) ) ] \qquad Formula 6$$

$${Q}_{α , i} = \frac{{k}_{rα , i}}{{μ}_{α , i}} {ψ}_{α , i} \qquad Formula 7$$

If elements E and E′ share interface i, the momentum balance can be represented according to Formula 8-11, below, where V is the volume of grid-block, superscript n is the previous time step, superscript n+1 is the current time step, densities ρ_{g,i}, ρ_{g,i}, and ρ_{g,i}, are determined by upstream weighting over the interface i; Δt is the time step, and Ψᵢ^{E,E′} is defined according to Formula 12, below.

$${ψ}_{i}^{E} + {ψ}_{i}^{{E}^{′}} = 0 \qquad Formula 8$$

$${[ V ϕ ( {ρ}_{g} {S}_{g} + \frac{{ρ}_{g s t}}{{B}_{o}} {R}_{g} {S}_{o} ) ]}^{n + 1} - {[ V ϕ ( {ρ}_{g} {S}_{g} + \frac{{ρ}_{g s t}}{{B}_{o}} {R}_{g} {S}_{o} ) ]}^{n} - Δ t {\sum }_{i} [ ( {ρ}_{g , i} \frac{{k}_{rg , i}}{{μ}_{g , i}} + \frac{{ρ}_{g s t}}{{B}_{o , i}} {R}_{g , i} \frac{{k}_{ro , i}}{{μ}_{o , i}} ) {ψ}_{i}^{E , {E}^{′}} ] + Δ {tVq}_{g} = 0 \qquad Formula 9$$

$${( V ϕ {ρ}_{o} {S}_{o} )}^{n + 1} - {( V ϕ {ρ}_{o} {S}_{o} )}^{n} - Δ t {\sum }_{i} ( {ρ}_{o , i} \frac{{k}_{ro , i}}{{μ}_{o , i}} {ψ}_{i}^{E , {e}^{′}} ) = Δ {tVq}_{o} = 0 \qquad Formula 10$$

$${( V ϕ {ρ}_{w} {S}_{w} )}^{n + 1} - {( V ϕ {ρ}_{w} {S}_{w} )}^{n} - Δ t {\sum }_{i} ( {ρ}_{w , i} \frac{{k}_{rw , i}}{{μ}_{w , i}} {ψ}_{i}^{E , {E}^{′}} ) = Δ {tVq}_{w} = 0 \qquad Formula 11$$

$${ψ}_{i}^{E , {E}^{′}} = \frac{{W}_{ii}^{{E}^{′}} {ψ}_{i}^{E} - {W}_{i i}^{E} {ψ}_{i}^{{E}^{′}}}{{W}_{i i}^{E} + {W}_{i i}^{{E}^{′}}} \qquad Formula 12$$

Formulas 8-11 are used by the nonlinear system, where the momentum equations rank behind the mass balance formulas. To guarantee unconditionally stable solutions, the nonlinear solver 110 applies a fully implicit scheme, which may be presented according to the Newton-Raphson method according to Formula 13, below, where x is the vector of unknowns, including p, z_{g}, zₒ, and π; z_{c} represents the mass fraction of component c; r is the residual vector; and J is the Jacobian matrix.

$${x}_{n + 1}^{k + 1} = {x}_{n + 1}^{k} - \frac{r ( {x}_{n + 1}^{k} )}{J ( {x}_{n + 1}^{k} )} \qquad Formula 13$$

The OBJ solver 120 simplifies that assembly of r and J, which are typically challenging to calculate when rock property models and phase behavior models are complex. The OBJ solver 120 reformulates Formulas 9-11 into operator forms, according to Formulas 14-22, below, where cᵣ is the rock compressibility factor; and p_{ref} is the reference pressure for porosity ϕₒ.

$${α}_{g} = [ 1 + {c}_{r} ( p - {p}_{γ e f} ) ] ( {ρ}_{g} {S}_{g} + \frac{{ρ}_{g s t}}{{B}_{o}} {R}_{g} {S}_{o} ) \qquad Formula 14$$

$${α}_{o} = [ 1 + {c}_{r} ( p - {p}_{ref} ) ] {ρ}_{o} {S}_{o} \qquad Formula 15$$

$${α}_{w} = [ 1 + {c}_{r} ( p - {p}_{ref} ) ] {ρ}_{w} {S}_{w} \qquad Formula 16$$

$${β}_{g , i} = {ρ}_{g , i} \frac{{k}_{rg , i}}{{μ}_{g , i}} + \frac{{ρ}_{g s t}}{{B}_{o , i}} {R}_{g , i} \frac{{k}_{ro , i}}{{μ}_{o , i}} \qquad Formula 17$$

$${β}_{o , i} = {ρ}_{o , i} \frac{{k}_{ro , i}}{{μ}_{o , i}} \qquad Formula 18$$

$${β}_{w , i} = ρ \frac{{k}_{rw , i}}{{μ}_{w , i}} \qquad Formula 19$$

$$V {ϕ}_{0} ( {α}_{g}^{n + 1} - {a}_{g}^{n} ) - Δ t {\sum }_{i} ( {β}_{g , i} {ψ}_{i}^{E , {E}^{′}} ) + Δ {tVq}_{g} = 0 \qquad Formula 20$$

$$V {ϕ}_{0} ( {α}_{g}^{n + 1} - {a}_{o}^{n} ) - Δ t {\sum }_{i} ( {β}_{o , i} {ψ}_{i}^{E , {E}^{′}} ) + Δ {tVq}_{o} = 0 \qquad Formula 21$$

$$V {ϕ}_{0} ( {α}_{g}^{n + 1} - {a}_{w}^{n} ) - Δ t {\sum }_{i} ( {β}_{w , i} {ψ}_{i}^{E , {E}^{′}} ) + Δ {tVq}_{w} = 0 \qquad Formula 21$$

Accordingly, the terms, which are dependent on rock and fluid properties (but are independent of spatially distributed properties), are reduced into simple operators that are uniformly discretized for the space of physical status for a simplified representation of the operators. Conceptually, the space of physical status for a black oil model is three-dimensional, where the axes are represented with p, z_{g}, and zₒ respectively. Here, z_{g}, and zₒ mean the mass fractions of gas and oil components in the mixture, respectively. These operator values are evaluated on the nodes, as the three parameters are sufficient to compute the dynamic properties that are required in the operators.

Accordingly, the operator values and their derivatives, required for the assembly of r and J, can be estimated through a multi-linear interpolation. For example, the OBL solver 120 is included in the fully implicit scheme, by applying the mass-based formulation that takes physical status as unknowns to solve the nonlinear system. The OBL solver 120 helps to guarantee the flexibility and extensibility of a framework for reservoir simulation, which makes implementation of the multipoint scheme MFD easier and more computationally efficient. Thus, a combination of these two solvers improves the development process of an advancing reservoir simulator.

The paired solvers 110, 120 are used to accurately solve complex simulations at geological scales, and are coupled in a fully-implicit parallel framework that applied massively parallel computations via a Message Passing Interface (MPI). The OBL solver 120 is applied to assemble the Jacobian matrix and residual vector at each nonlinear iteration, which allows the paired solvers 110, 120 to produce a Jacobian Matrix (J) and residual vector (r) for each nonlinear iteration, and perform several nonlinear iterations until an end criteria is reached. After the end criteria is reached, the values obtained are used to populate a mesh 130 of an oil and gas reservoir site being simulated with the various permeability, porosity, pressure, water saturation, etc.

FIG. 2 is a flowchart of an example method 200 for implementing an oil and gas reservoir simulator, according to embodiments of the present disclosure. Method 200 begins at block 210, where the simulator reads in the simulation parameters. In various embodiments, the simulation parameters include various

At block 220, the simulator loads the mesh and decomposes the domain to subdomains for the parallel computations. In various embodiments, the mesh represents the geographical area under analysis for oil and gas reservoirs, and includes the topographical and known subterranean features of the area.

At block 230, the simulator constructs shared cells and ghost cells between the subdomains for the MPI communications.

At block 240, the simulator discretizes the governing equations. As discussed in relation to FIG. 1, the governing equations of Formulas 1-5 are discretized to yield Formulas 6-7.

At block 250, the simulator couples the wells with the subdomains by finding the wells intersected cells.

At block 260, the simulator solves for the nonlinear equations. In various embodiments the nonlinear solver 110 solves for the nonlinear equations across several iterations until an end criteria is satisfied (e.g., a set number of iterations, a time limit, etc.). The nonlinear equations may include those set forth in Formulas 8-12 described herein.

At block 270, the simulator estimates the operator values and the derivatives thereof. In various embodiments, these values and derivatives are determined according to Formulas 14-22 described herein.

At block 280, the simulator determines whether the values calculated in block 270 have converged. When the convergence criteria are met, method 200 proceeds to block 290. When the convergence criteria are not met, the combined scheme increments the count for the Newton-Raphson iteration for analysis (e.g., k++), and method 200 returns to block 270 to estimate the operator values and derivative thereof for the next Newton-Raphson iteration. When the end criteria are reached (e.g., N=Nₘₐₓ or k=kₘₐₓ), method 200 may conclude.

At block 290, the simulator outputs the results of the OBL solver to the MFD solver. The combined scheme increments the count for the time step for analysis (e.g., N++), and returns to block 160 to solve the nonlinear equations for the next time step.

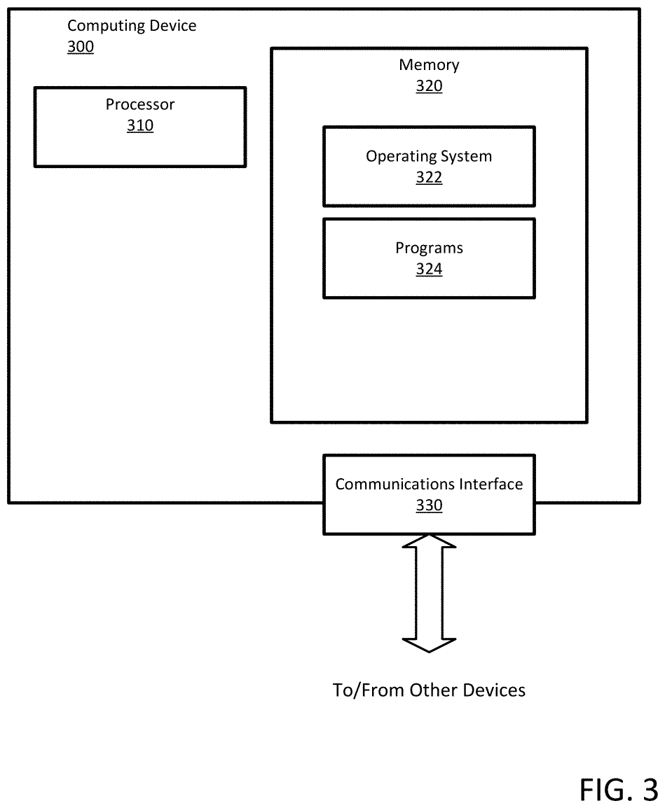

FIG. 3 illustrates a computer system 300, such as may be used to perform method 200 described in relation to FIG. 2, according to aspects of the present disclosure. The computer system 300 may include at least one processor 310, a memory 320, and a communication interface 330. In various aspects, the physical components may offer virtualized versions thereof, such as when the computer system 300 is part of a cloud infrastructure providing virtual machines (VMs) to perform some or all of the tasks or operations described for the various devices in the present disclosure.

The processor 310 may be any processing unit capable of performing the operations and procedures described in the present disclosure. In various aspects, the processor 310 can represent a single processor, multiple processors, a processor with multiple cores, and combinations thereof. Additionally, the processor 310 may include various virtual processors used in a virtualization or cloud environment to handle client tasks.

The memory 320 is an apparatus that may be either volatile or non-volatile memory and may include RAM, flash, cache, disk drives, and other computer readable memory storage devices. Although shown as a single entity, the memory 320 may be divided into different memory storage elements such as RAM and one or more hard disk drives. Additionally, the memory 320 may include various virtual memories used in a virtualization or cloud environment to handle client tasks. As used herein, the memory 320 is an example of a device that includes computer-readable storage media, and is not to be interpreted as transmission media or signals per se.

As shown, the memory 320 includes various instructions that are executable by the processor 310 to provide an operating system 322 to manage various operations of the computer system 300 and one or more programs 324 to provide various features to users of the computer system 300, which include one or more of the features and operations described in the present disclosure. One of ordinary skill in the relevant art will recognize that different approaches can be taken in selecting or designing a program 324 to perform the operations described herein, including choice of programming language, the operating system 322 used by the computer system 300, and the architecture of the processor 310 and memory 320. Accordingly, the person of ordinary skill in the relevant art will be able to select or design an appropriate program 324 based on the details provided in the present disclosure.

The communication interface 330 facilitates communications between the computer system 300 and other devices, which may also be computer system 300 as described in relation to FIG. 3. In various aspects, the communication interface 330 includes antennas for wireless communications and various wired communication ports. The computer system 300 may also include or be in communication, via the communication interface 330, one or more input devices (e.g., a keyboard, mouse, pen, touch input device, etc.) and one or more output devices (e.g., a display, speakers, a printer, etc.).

Accordingly, the computer system 300 is an example of a system that includes a processor 310 and a memory 320 that includes instructions that (when executed by the processor 310) perform various aspects of the present disclosure. Similarly, the memory 320 is an apparatus that includes instructions that when executed by a processor 310 perform various aspects of the present disclosure.

Without further elaboration, it is believed that one skilled in the art can use the preceding description to utilize the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

We claim:

1. A method, comprising:
reading in simulation parameters for a simulated oil and gas reservoir site;
solving an initial iteration of nonlinear equations for simulating the simulated oil and gas reservoir site based on the simulation parameters;
estimating initial operator values and initial derivatives of the initial operator values for the simulated oil and gas reservoir site until the initial operator values meet a convergence criteria with the initial derivatives;
producing an initial output based on the initial operator values;
solving a final iteration of the nonlinear equations for simulating the simulated oil and gas reservoir site based on the simulation parameters and the initial output;
estimating final operator values and final derivatives of the final operator values for the simulated oil and gas reservoir site until the final operator values meet the convergence criteria with the final derivatives; and
loading oil and gas survey results into cells of a mesh representing the simulated oil and gas reservoir site based on the final output.

2. The method of claim 1, wherein a number of iterations between the initial iteration and the final iteration is operator-defined.

3. The method of claim 1, wherein the nonlinear equations include

4. The method of claim 1, where the initial operator values, final operator values, initial derivatives, and final derivatives are estimated according to formulas

5. The method of claim 1, wherein the oil and gas survey results include a permeability, a porosity, a pressure, and a water saturation for the simulated oil and gas reservoir site.

6. The method of claim 1, wherein the simulation parameters include the mass fraction of gas, the mass fraction of oil, a reference pressure for a given porosity.

7. The method of claim 1, wherein the simulation parameters for the simulated oil and gas reservoir site include:
reservoir porosity;
phase density of oil;
phase density of gas;
phase density of water;
saturation of oil;
saturation of gas;
saturation of water;
velocity of oil;
velocity of gas;
velocity of water;
a formation volume factor;
gas solubility;
a permeability tensor;
viscosity; and
pressure.

8. A system, comprising:
a processor; and
a memory including instructions that when executed by the processor perform operations including:
reading in simulation parameters for a simulated oil and gas reservoir site;
solving an initial iteration of nonlinear equations for simulating the simulated oil and gas reservoir site based on the simulation parameters;
estimating initial operator values and initial derivatives of the initial operator values for the simulated oil and gas reservoir site until the initial operator values meet a convergence criteria with the initial derivatives;
producing an initial output based on the initial operator values;
solving a final iteration of the nonlinear equations for simulating the simulated oil and gas reservoir site based on the simulation parameters and the initial output;
estimating final operator values and final derivatives of the final operator values for the simulated oil and gas reservoir site until the final operator values meet the convergence criteria with the final derivatives; and
loading oil and gas survey results into cells of a mesh representing the simulated oil and gas reservoir site based on the final output.

9. The system of claim 8, wherein a number of iterations between the initial iteration and the final iteration is operator-defined.

10. The system of claim 8, wherein the nonlinear equations include

11. The system of claim 8, where the initial operator values, final operator values, initial derivatives, and final derivatives are estimated according to formulas

12. The system of claim 8, wherein the oil and gas survey results include a permeability, a porosity, a pressure, and a water saturation for the simulated oil and gas reservoir site.

13. The system of claim 8, wherein the simulation parameters include the mass fraction of gas, the mass fraction of oil, a reference pressure for a given porosity.

14. The system of claim 8, wherein the simulation parameters for the simulated oil and gas reservoir site include:
reservoir porosity;
phase density of oil;
phase density of gas;
phase density of water;
saturation of oil;
saturation of gas;
saturation of water;
velocity of oil;
velocity of gas;
velocity of water;
a formation volume factor;
gas solubility;
a permeability tensor;
viscosity; and
pressure.

15. A non-transitory computer-readable storage medium including instructions that when executed by a processor perform operations comprising:
reading in simulation parameters for a simulated oil and gas reservoir site;
solving an initial iteration of nonlinear equations for simulating the simulated oil and gas reservoir site based on the simulation parameters;
estimating initial operator values and initial derivatives of the initial operator values for the simulated oil and gas reservoir site until the initial operator values meet a convergence criteria with the initial derivatives;
producing an initial output based on the initial operator values;
solving a final iteration of the nonlinear equations for simulating the simulated oil and gas reservoir site based on the simulation parameters and the initial output;
estimating final operator values and final derivatives of the final operator values for the simulated oil and gas reservoir site until the final operator values meet the convergence criteria with the final derivatives; and
loading oil and gas survey results into cells of a mesh representing the simulated oil and gas reservoir site based on the final output.

16. The computer-readable storage medium of claim 15, wherein a number of iterations between the initial iteration and the final iteration is operator-defined.

17. The computer-readable storage medium of claim 15, wherein the nonlinear equations include

18. The computer-readable storage medium of 15, where the initial operator values, final operator values, initial derivatives, and final derivatives are estimated according to formulas

19. The computer-readable storage medium of claim 15, wherein the oil and gas survey results include a permeability, a porosity, a pressure, and a water saturation for the simulated oil and gas reservoir site.

20. The computer-readable storage medium of claim 15, wherein the simulation parameters include the mass fraction of gas, the mass fraction of oil, a reference pressure for a given porosity.
